(19) United States
(12) Patent Application Publication
(10) Pub. No.: US 2008/0273546 A1
(43) Pub. Date: Nov. 6, 2008

(54) DATA SWITCH AND A METHOD OF SWITCHING

(75) Inventors: Ian David JOHNSON, Ferring (GB); Paul Graham Howarth, Sale (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Havant (GB)

(21) Appl. No.: 12/114,065

(22) Filed: May 2, 2008

Related U.S. Application Data
(60) Provisional application No. 60/924,188, filed on May 3, 2007.

(51) Int. Cl. H04L 12/56

(52) U.S. Cl. 370/419

(57) ABSTRACT

The invention relates to a data switch, comprising: plural input ports each for receiving data cells from a respective link; plural output ports each for providing data cells to a respective link; a switch fabric for selectively enabling a data cell received at one of the plural input ports to be switched to one or more of the plural output ports; and a switch scheduler comprising a cut-through arbiter arranged to schedule the switching of a received data cell before the entirety of the data cell is received.

### CROSS REFERENCE TO RELATED APPLICATIONS

This application claims priority to U.S. provisional application Ser. No. 60/924,188, filed May 3, 2007, the entire contents of which is incorporated by reference herein in its entirety.

The present invention relates to a data switch and a method of switching.

In embodiments the invention relates to a data switch having plural input ports and plural output ports, such as the type of switch that may be connected in a network of like or similar switches. As used herein, the term “switch” is synonymous with the term “data switch”.

Conventional data switches such as Asynchronous Transfer Mode (ATM) switches are arranged and configured to switch data frames of fixed sizes. Typically a data frame will be made up of plural data cells, a data frame being a unit of data according to any particular communications protocol and a data cell being a constituent element or part of a data frame. As used herein a data cell is a smaller part of a data frame, of a size to correspond to the primary scheduling granularity for the switch.

Switches such as these are able to handle and switch indefinitely long streams of data cells using simple Time Divisional Multiplexing (TDM) arrangements for the scheduling of data cells at regular intervals through the switch. They are also able to deal with multicast data streams, i.e. a stream of data cells that is to be routed from a single input port to plural output ports, using the inherent multicasting ability of cross-bar switches.

A problem with conventional ATM-style switches occurs when there is a need to switch frames that are made up of small variable number multiples of the switch's natural cell size, such as, say, 1 to 10 data cells. In such cases the time needed to set up the TDM schedule (a convoluted process often done in software) would be comparable with the length of the data frame. This leads to poor latency performance even in an otherwise idle switch.

According to a first aspect of the present invention, there is provided a data switch for switching received data frames made up of one or more data cells, the switch comprising: plural input ports each for receiving data frames from a respective link; plural output ports each for providing data frames to a respective link; a switch fabric for selectively enabling a data frame received at one of the plural input ports to be switched to one or more of the plural output ports; and a switch scheduler comprising a cut-through arbiter arranged to schedule the switching of a received data cell before the entirety of the data frame of which it is a part is received.

The switch enables both unicast and multicast frames of variable but small lengths, i.e. a small multiple of the switches natural cell size, to be handled, providing for cut-through arbitration in which the scheduling of the transmission of a frame through the switch is started before the frame has been completely received at the input of the switch. Thus, good latency performance is achieved by the switch. Whereas with traditional ATM-style switches problems appear when there is a need to switch frames that are made up of small, variable-number multiples of the switch's natural cell size such as say, one to ten cells, with the switch of the present invention, such data switching and control is easily achieved and managed.

Preferably, the switch comprises one or more cell arbiter stages for scheduling connections available after operation of the cut-through arbiter.

As the scheduler operates it may be arranged to add entries, e.g. by setting bits, to a connection matrix used to represent the connections between input ports and output ports in any switch cycle. Clearly, the fuller the connection matrix, the greater the efficiency of the switch.

Preferably, each input port is arranged to divide up a received data frame into plural data cells as the frame arrives at the input port and the switch is arranged to schedule the routing of a first data cell from the received frame before the last data cell of the frame has been received at the input port.

By dividing the received data frames into data cells sized for easy manipulation and scheduling by the switch a simple and robust switch is provided capable of cut-through routing whilst also ensuring good latency performance and efficiency.

Preferably, the scheduler comprises plural cell state buffers for receiving and storing data about data frames and/or cells received at one or more of the input ports. In a preferred example, there is a dedicated cell state buffer for each of the plural input ports.

Preferably, the cut-through arbiter is arranged to select from the available data cells, a data cell for transmission, and when selected to communicate with the respective input port and the switch fabric to cause the selected data cell to be switched.

The decision to switch a data cell may be made in dependence on various parameters associated with the data cell or frame. These preferably include one or more of (a) the time that the data cell has been stored at the input port; (b) in the case of a multicast data cell, the fan-out of the data cell; (c) the availability of the designated destination(s) of the data cell; and (d) the required connection rate and duration of the flow of which the data cell is a part.

In a preferred example, after the cut-through arbiter has operated in a switching cycle, one or more of the cell arbiter stages operates to schedule connections, wherein the or each of the cell arbiter stages is arranged only to schedule single cells for transmission to each egress port independent of other characteristics of the cell. In other words, the cell arbiter stage may be configured to schedule data cells for transmission entirely independently of other factors such as those used by the cut-through arbiter. The decisions may be made based purely on available connections within any particular connection matrix such that efficiency of the switch is maximised.

According to a second aspect of the present invention, there is provided a method of switching data cells across a data switch, the switch comprising plural input ports and plural output ports, a switch fabric for selectively enabling a data cell received at one of the plural input ports to be switched to one or more of the plural output ports and a switch scheduler comprising a cut-through arbiter arranged to schedule the switching of a received data cell before the entirety of the data frame of which it is a part is received, the method comprising at one of the input ports, starting to receive a data frame for onward transmission; as the data frame is received, dividing the data frame into data cells for handling by the switch; and pre-scheduling the onward transmission of the entire set of data cells which comprise the data frame before the whole data frame has been received.

The method preferably comprises: at one of the input ports, starting to receive a data frame for onward transmission; as the data frame is received, dividing the data frame into data cells for handling by the switch; and scheduling the onward transmission of a data cell before the entire data frame of which it is a part has been received.

According to a further aspect of the present invention, there is provided a network of data switches in which at least one of the switches is a switch according to the first aspect of the present invention.

Examples of the present invention will now be described in detail with reference to the accompanying drawings, in which:

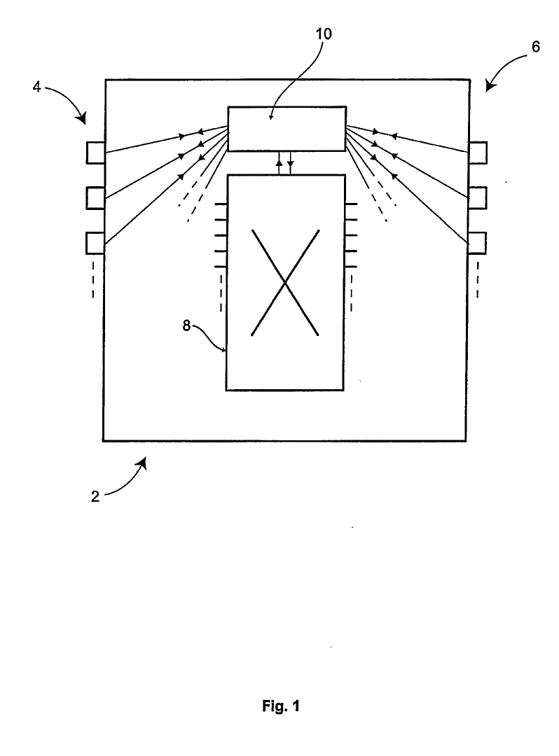

FIG. 1 is a schematic representation of a switch;

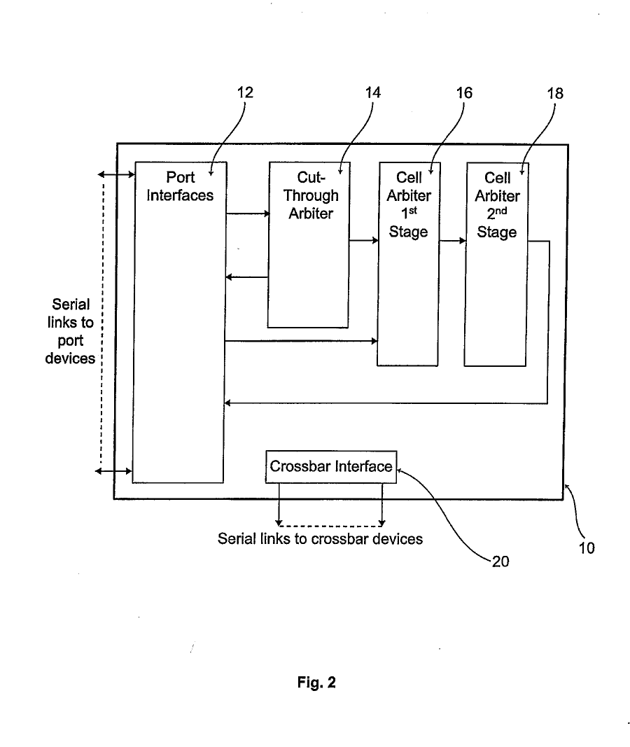

FIG. 2 is a schematic representation of a control unit for use in the switch of FIG. 1;

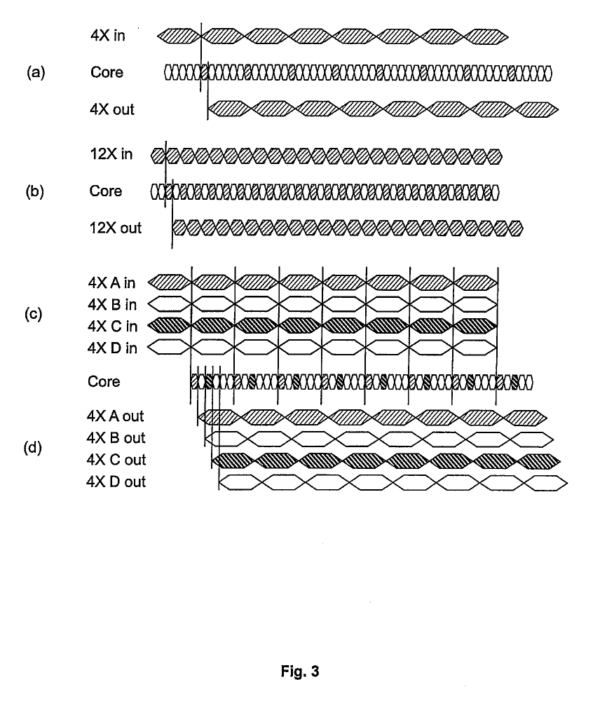

FIG. 3 is a timing diagram showing an example of data transfer through a switch such as that shown in FIG. 1; and

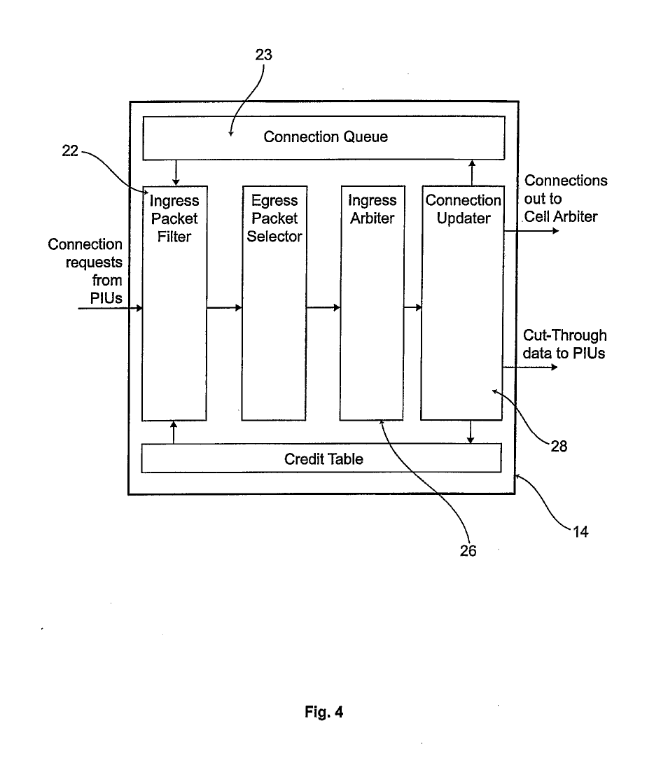

FIG. 4 is a schematic representation of one possible configuration for a cut-through arbiter.

FIG. 1 shows a schematic representation of a switch 2 having plural input ports 4 and plural output ports 6. The switch comprises a switch fabric 8, also referred to as a crossbar matrix, which serves to enable physically data received at one or more of the input ports to be routed to one or more desired output ports 6. A control unit 10 is provided which serves to control the passage of data through the switch.

The control unit 10 may be referred to as the master device and it serves to provide the overall scheduling and arbitration functionality for the switch. As will be explained below, the master device 10 supports cut-through routing, i.e. a process by which the switch starts to send out a data frame before the frame has been fully received at an input port. The master device 10 may also serve to enable core multicast switching to be achieved in which the same data frame may be sent to multiple destination output ports using the built-in crossbar matrix 8 of the switch 2 rather than by replicating the data at the input ports 4 and sending it to each destination separately.

The master device 10 functions to manage the flow of various types of data through the switch, maintaining a configurable balance between prioritisation, i.e. ensuring that high priority traffic is serviced quickly, fairness, i.e. ensuring that low priority traffic is serviced in a timely fashion, and efficiency, i.e. ensuring that as much data as possible passes through the switch 2 in a given time period.

As will be explained below, the master device 10 has three main interfaces which serve to enable communication between the master device 10 and the input and output ports 4 and 6 and to enable communication between the master device 10 and the switch fabric 8. A configuration and diagnostic interface is also provided but does not form part of the present invention and will not therefore be described further.

The switch enables both unicast and multicast frames of variable but small lengths, i.e. a small multiple of the switches natural cell size, to be handled, providing for cut-through arbitration in which the scheduling of the transmission of a frame through the switch is started before the frame has been completely received at the input of the switch. Thus, good latency performance is achieved by the switch. Whereas with traditional ATM-style switches problems appear when there is a need to switch frames that are made up of small, variable-number multiples of the switch's natural cell size such as say, one to ten cells, with the switch of FIG. 1, such data manipulation is possible.

The time needed to set up the TDM schedule for a conventional ATM-style switch would be comparable with the length of the frame which would result in poor latency performance even in an otherwise idle switch. Thus, the switch of FIG. 1 achieves prioritisation, fairness and efficiency even when the data flow received by the switch comprises one or more streams of data made up of data frames made up themselves of variable numbers of data cells of the switch's natural data cell size.

FIG. 2 shows a schematic representation of a master device 10 such as that shown in the switch of FIG. 1. The master device 10 comprises port interfaces 12 arranged possibly via serial links to communicate with port devices 4 and 6 of the switch 2. The master device 10 shown in FIG. 1 is shown schematically such that the input ports and output ports to the master device 10 are shown on opposite sides of the master device 10. It will be appreciated that in fact the ports of the master device will typically be bi-directional ports.

The master 10 comprises port interfaces 12 in communication with a cut-through arbiter 14 and a first cell arbiter stage 16. In this example, a second cell arbiter stage 18 is also provided. A crossbar interface 20 is provided which provides the interface with the switch fabric 8 of the switch 2. The physical connection between the port interfaces 12 and the input and output ports 4 and 6 is typically provided via serial links to the port devices 4 and 6. In addition, the physical interface between the crossbar interface 20 and the crossbar matrix or switch fabric 8 is preferably also provided via serial links.

The port interfaces 12 handle the communications with the input and output ports 4 and 6, managing, formatting and presenting connection requests for arbitration. Connection requests typically include information about the destination(s) each frame is to be sent to, the length of the frame and the rate at which the frame needs to be sent to its destination(s). Since this may be quite a significant amount of information that would need to be stored at each frame, only a limited number of connection requests can be stored for each input port 4.

Each connection request is allocated a cell state buffer on arrival at the master device 10. Connection requests that have passed arbitration are converted to “grant” commands for passing to the port devices 4. A frame's cell state buffer is made available for use by a subsequent frame when the last cell in respect of which it stores information is sent to its last identified destination. The port interfaces 12 are also responsible for managing flow control for their associated ports, passing on backpressure information to the arbiters and dealing with cell requests for blocked destinations.

The cut-through arbiter 14 functions to receive connection requests via all of the port interfaces and selects as many of the highest-weighted connection requests as possible that can be connected simultaneously. The cut-through arbiter 14 handles multicast as well as unicast requests and takes into account the age of a frame, i.e. the length of time the frame has been waiting to be scheduled, the fan-out, i.e. the number of multicast destinations, the required connection rate and duration and the data flow of which the frame is part Preferably, a credit-based scheme is used to enforce fairness, for example, allowing several frames from one source to pass in the same time as a long frame from another source.

Thus, the cut-through arbiter enables the set of cells that comprise a data frame to be scheduled for passage and to begin passing through the switch before the complete data frame has arrived at the respective input port. Therefore, in effect, the switch and scheduler in combination are able to achieve what may be referred to as transient time division multiplexing (TTDM), i.e. time division multiplexing on a very short time scale.

Another way of viewing this is with regard to the normal routing method which is known as 'store and forward, whereby the entire data frame must arrive and be kept in a buffer memory until it can be scheduled for connection and subsequently transmitted, on a typically cell asynchronous basis through the switch core.

The cut-through arbiter is able to perform ingress to egress rate matching. This is achieved by dynamically pre-booking or reserving the arbiter cell connection slots in advance. Implicit within this capability is the option for a receiving egress port to begin transmission of a first part of a data frame with the reliance that the TTDM capable scheduling and arbitration logic will deliver the remainder of the data frame such that there will be no breaks or discontinuities in the egress data stream. In other words, reliance is made on the fact that certain slots are dynamically pre-scheduled to be used for cells of a certain frame.

Furthermore, in the circumstance where an egress port has a lower line data transmission rate than an ingress port, then the TTDM capability can be used to match the different rates by ‘slowing down’ the data movement through the switch core. Moreover, an ingress port that knows it is transmitting to a higher rate egress port may accumulate in its local buffer sufficient of the data frame such that when the arbiter grants a connection the entire data frame may pass through to the egress with the remainder of the ingress data arriving while the egress has begun external line transmission.

Time division multiplexing is historically achieved as a circuit switching function, with typically long set-up intervals in the order of milliseconds and substantially extended connection durations. In a cell switching environment such as that of the switch described herein, connection set up latencies may be in the order of nanoseconds with connections that exist for similarly short durations.

In a conventional ATM switch, the cell forwarding policy focuses primarily on fairness and usually avoids latency issues. A switch as described herein achieves fairness and avoids latency issues.

FIG. 4 shows a schematic representation of a cut-through arbiter 14. In this particular example, its operation centres on the management of a Connection Queue 23 for each egress port, where the Connection Queue 23 holds information about which frame at which ingress port is to have a cell scheduled at various times in the future. The amount of information stored about future connections is sufficient to ensure that the longest allowable frame (e.g. 576 bytes) at the slowest allowable rate can be completely scheduled. There is preferably a separate entry in the Connection Queue 23 for each switching cycle at each egress port, containing the following items:
Connection Allocated flag
Multicast ID, if appropriate
Source Port and Flow

This information is sufficient to identify the frame to be scheduled from each egress port at any given time.

The cut-through arbiter includes an ingress packet filler 22 arranged to receive connection requests from the port interface units PIUS. The Ingress Packet Filter 22 accepts the highest-weighted frames from each PIU and removes some of them from consideration. First, any port that does not have sufficient credit to send a frame of a length required to a given egress is removed from consideration for that egress. If there are no frames with sufficient credit, the amount of credit for all ports is increased.

Next, a Connection Mask is built up for each destination of a frame, based on the frame's requested connection rate. A bit is set in the Connection Mask if the frame will need to have a cell scheduled in a given time slot. For example, if there are two frames of the same length but one that needs a faster connection than the other, both packets will have the same number of bits set in the Connection Mask but the faster frame's bits will be closer together, representing the connections being made in a smaller number of elapsed switch cycles.

The Connection Mask is then compared with the Connection Allocated flags in the Connection Queue for the required output(s). If any bits in the Connection Mask are set in the same positions as the Connection Allocated flags for the egress, then the frame cannot be scheduled to that egress during the current switch cycle, so that frame is removed from consideration by that egress port. Details of all frames that have not been removed for consideration are now forwarded to the Egress frame Selector, which simply selects the highest-weighted frame for each egress port. If there are multiple frames with the same weight, one is chosen on, e.g., a round-robin basis.

The final phase of cut-through arbitration takes place in the Ingress Arbiter 26. The Ingress Arbiter 26 serves to prevent conflicts for resources at the ingress ports. Each ingress port examines the frames that require a connection to it. Any potential connection for a frame that is already fully present in a multi-cast cache queue MCQ where present or that has a cut-through connection already active to one or more different destinations is allowed to pass. For any remaining frames, the highest-weighted is chosen, using a round-robin in the event of a tie. This algorithm ensures that only one cell need be loaded from TP to TX in any one switch cycle.

Having decided which connections to make, control passes to a Connection Updater 28. This decrements the credit for all scheduled cells and shifts along the Connection Queue ready for the next switch cycle. It sets up the connection data ready to pass on to the Cell Arbiter and passes back details of the cut-through connections to the PIUs so that they can update their active cell state buffers and weightings etc. It will be appreciated that this is merely one possible way in which the cut-through arbitration can be achieved.

Referring again to FIG. 2, the first cell arbiter stage 16 functions to improve the efficiency of the switch as a whole. It is configured and arranged to fit individual cells from the heads of frames into the gaps between connections that the cut-through arbiter leaves. Like the cut-through arbiter 14, it preferably uses a credit-based weighting scheme to enforce fairness.

The first cell arbiter stage 16 only attempts to schedule single cells for each egress port, taking no account of the data rate or flow etc. In the example of FIG. 2, a second cell arbiter stage 18 is provided. It will be appreciated that any number of cell arbiter stages may be provided, each functioning to complete as many connections as are possible within a particular switching cycle. Thus, if in any one switching cycle the connections to be made are thought of as a connection matrix, as each of the cut-through arbiter and first and second stage cell arbiters do their jobs further entries in the connection matrix are made. The result is that the switch is highly efficient whilst simultaneously ensuring that prioritisation is respected and fairness achieved.

The crossbar interface 20 serves to convert the connection information as generated by the various arbiters into a format suitable for transmission to the crossbar devices or switch fabric 8. A set of connection information, i.e. the input port/output port connections to be established on each switch cycle, is sent to each output on every switch cycle. A switch cycle is the time taken to send one data cell across the crossbar. Thus, a mechanism is provided by which the required input/output port connections can be made on each switch cycle. The arbiters are pipelined together and the set of connection information builds up as it passes down the pipeline, starting out with no connections and building up connections as it passes through each phase of arbitration.

In one particular example, multicast cache queues (MCQ) may be provided in the crossbar matrix 8. Our co-pending patent application having the same filing date of the present application and attorney reference AF2/P10492US describes the MCQ configuration in detail and its entire contents are hereby incorporated by reference.

Typically, there are eight slots available per ingress port in each of the MCQ's within the crossbar device. Thus, in this example, the crossbar can store up to eight multicast frames for each ingress port. In the interests of efficiency, as many of these slots as possible are preferably occupied by in-progress cut-through transfers as possible. However, it is also desirable that cells from multicast frames can be scheduled (at least for the start of the frame) by the cell arbiter stages 16 and 18, to take advantage of any bandwidth not claimed by the cut-through arbiter 14.

A problem with this is that the cell-arbiter stages 16 and 18 can potentially choose nearly any frame from those available at a particular ingress port, which can lead to small parts of lots of different frames being scheduled rather than the more desirable large parts of a small number of frames.

Having a significant number of frames in progress at the same time is not desirable for the egress ports 6 as they have to create a separate reassembly context for each of these frames. In addition, by enabling the cell-arbiter stages 16 and 18 to choose nearly any frame from those available at a particular ingress port, the cell-arbiter stages use up slots in the MCQ's that could more efficiently be used by the cut-through arbiter 14. Last, blocking for the ingress port due to its cell state buffers being clogged up with partly-scheduled frames can also occur.

These problems may be addressed by reserving a number of MCQ slots for use exclusively by the cut-through arbiter, the remaining slots being usable by either of the cut-through arbiter or the cell-arbiter stages. The number of MCQ slots for use exclusively by the cut-through arbiter is preferably programmable or variable in accordance with user or situation preference.

A particular example of the operation of the switch and the master will now be described. On arrival of a data cell (at the start of a frame) at an input port of the switch, information about the received cell is stored in a vacant slot in the cell state buffer for that particular ingress port.

As explained above, it is typical that a switch core will have to transfer a finite quantity of information i.e. number of bytes, per cycle. In order to achieve the required throughput rates this tends to become the primary scheduling granularity for the switch. All data frames arriving, unless as with ATM they are of a fixed size which typically matches the core proportions, are subdivided into smaller parts referred to herein as “cells”, which each pass through the core on a cycle by cycle basis.

Two mechanisms are preferably provided for preventing blocking due to back pressure or congestion as a result of the cell state buffer filling up. A first approach uses an “unqueue” command. When such a command is issued, an arriving cell request for a destination that is blocked is rejected so that the ingress port must retry the request later. A second approach is use of a “dequeue” command in which entries from the cell state buffer are removed for destinations that have become blocked. Again, the ingress port in question is notified and must retry the requests later.

Once one or more requests are stored within the cell state buffers, arbitration begins by each ingress port 4 selecting the highest-weighted frames (in respect of which a request is stored) from its cell state buffer. First of all, frames for which all of the destinations that have not yet been granted cut-through arbitration are asserting backpressure are disregarded. Frames for which all of the destinations have been granted cut-through arbitration are also disregarded since they have no further need for arbitration.

The weighting for the remaining cells is then directly proportional to the amount of time the cell has been present in the buffer up to an implementation-dependent limit, the weighting for the flow that the frame belongs to, and inversely proportional to the fan-out of the frame. It will be appreciated that where it is stated that a cell is present in the buffer, or other words to that effect, what is meant is that a request in respect of the cell is stored in the buffer, not the physical data constituting the cell itself.

The weighting is boosted if, for a multicast frame, cut-through arbitration has been successful for one of its destinations. This weighting boost is there to take advantage of the fact that the data may be in a cache in the crossbar device and hence available for scheduling to multiple egress ports. If there are no free slots in the MCQ for the ingress port in the crossbar device, no new cut-through can be started from that port, so all multicast cells that do not have a cut-through connection in progress already are disregarded. A similar process removes unicast cells from consideration in a corresponding circumstance.

A number, which may be implementation-dependent, of the highest-weighted frames at each ingress are then forwarded for arbitration by the egress stage of the arbiter. Its job is to select, from all of the frames being offered to any one egress port, just one of those frames. Each egress port allocates credit to each ingress port, and each cut-through cell that is passed from that ingress port uses up a unit of credit. When the credit is used up, no further frames from that ingress are scheduled to that egress. When there is no more data to be sent from ports that still have credit left, all ports are given more credit. Thus, fairness and efficiency may be achieved.

The frame that is selected is the one with the highest weight after discounting ingress ports with no credit left, frames for flows that are back pressured and frames for which the requested state can be allocated. If there is more than one frame with the same weight, one is chosen based on, for example, a round-robin selection method. Since each ingress port selects a frame independently of all of the other egress ports, fragmentation of multicast frames, i.e. the process by which a multicast frame is not sent to all of its destination ports in the same switching cycle, is almost inevitable.

At this point, a frame has been selected to be sent to each egress port. However, it is quite possible that different egress ports will have selected different frames from amongst the frames presented for consideration by that ingress port. Any frames that will be present in the MCQ in the crossbar devices can be processed, so those connections are allowed to proceed. If there are any remaining frames, the one with the highest weight is chosen. If there is more than one frame with the same weight, as above one may be chosen based on a round-robin selection method. It is necessary to remove all but one of the frames that are not in the MCQ in the crossbar devices because only one cell can be loaded from the ingress port to the crossbar devices in any one switching cycle.

The rate and length requirements of all of the selected frames is then stored within the master so that the required connections can be allocated for each cell of the frame at the requested rate. Any new connections that are requested must fit around these previously-allocated connections.

FIG. 3A to 3D show timing diagrams to illustrate how 4× and 12× data streams use different connection rates in the switch core and how in the case of FIGS. 3C and 3D, multiple 4× data streams can be interleaved in the switch core.

In FIGS. 3A and 3B a single data stream is routed through the core. The difference in connection rates between the input data and the switch core means that the switch has the ability to interleave independent data streams from different input ports. This can be seen with reference to FIGS. 3C and 3D.

At this point, the work of the cut-through arbiter is done. However, it is likely, particularly on a busy system, that due to contention there are many egress ports that do not have an allocated connection for every switching cycle. This represents inefficiency in the operation of the switch as a whole the vacant time slots are effectively wasted. The arbiter attempts to fill these gaps by generating one-off connections for single data cells. These are the same data cells that form the cells that the cut-through arbiter is trying to schedule. Each cell that is sent in this way effectively reduces the length of the frame by one cell for the destination to which it is sent. Arbitration for these single data cells preferably occurs in multiple stages. Each of the stages fills in many of the gaps left by contention in the set of connections fed into it.

In a preferred example, the first phase of the cell arbiter involves taking a set of connection requests and thinning them out by removing requests that will not be considered by the arbiter. In one example, each ingress port creates a bit field with one bit representing each egress port. A bit is set in the field if that ingress port has any frame with any data which:
i) is to be sent to that egress port;
ii) has not had a connection allocated by the cut-through arbiter; and,
iii) is not in a backpressured flow.

This bit field is thinned out by discarding all requests to egress ports 6 that already have an allocated connection and all requests from input ports 4 that have an allocated connection that is not sourced directly from the MCQ in the Matrix devices, or from input ports that do not have any available slots or tags for the type of cell being requested. The requests are further thinned out by removing all of those that have run out of credit, using a similar credit-based scheme to that used by the cut-through arbiter 14.

The second phase of the cell arbiter involves removing contention for egress ports. Each egress port selects just one request for that port from all of the inputs requesting a connection to it. Preferably, this is done using a round-robin based selection mechanism. With only one remaining request for each egress port, there is no longer any contention for that port.

The final phase of the cell arbiter involves removing contention for ingress ports. Each ingress port selects just one request from that port from all of the remaining requests. Preferably, this is done using a round-robin based selection mechanism. With only one remaining request from each ingress port, there is no longer any contention for that port.

All of the remaining requests are now considered to be connections, and are added to the set of connections made by the cut-through arbiter 14 for the current switching cycle.

The resulting connection configuration information is used to update the cell state buffers. The lengths of each frame for which a cell has been sent is decremented, which may result in a cell state buffer emptying and becoming ready to accept a new frame. Flow information is added to the connection configuration for cells scheduled by the Cell Arbiter (the Cell Arbiter having no inherent knowledge of flows). When the Cell Arbiter creates a connection, if there is already a non-cut-through frame in progress between the same ports, the same frame is chosen so as to reduce the number of reassembly contexts required in the egress port.

The connection configuration information is now ready to be sent to the other devices in the system. The crossbar devices 8 set up the connections in their crossbar and the port devices transmit and receive the data. In the case where the arbiter has selected data from the MCQ in the crossbar devices, this data is transmitted too. The system timing is aligned so that data originating from ingress ports and crossbar devices arrives at their respective egress ports at the same time.

The process is pipelined so that a new set of connections can be created every few system clock cycles (one switch cycle being a small number of clock cycles).

Embodiments of the present invention have been described with particular reference to the examples illustrated. However, it will be appreciated that variations and modifications may be made to the examples described within the scope of the present invention.

1. A data switch for switching received data frames made up of one or more data cells, the switch comprising:
plural input ports each for receiving data cells from a respective link;
plural output ports each for providing data cells to a respective link;
a switch fabric for selectively enabling a data frame received at one of the plural input ports to be switched to one or more of the plural output ports; and
a switch scheduler comprising a cut-through arbiter arranged to schedule the switching of a received data cell before the entirety of the data frame of which it is a part is received.

2. A switch according to claim 1, comprising one or more cell arbiter stages for scheduling connections available after operation of the cut-through arbiter.

3. A switch according to claim 1, in which each input port is arranged to divide up a received data frame into plural data cells as the frame arrives at the input port and the switch is arranged to schedule the routing of a first data cell from the received frame before the last data cell has been received at the input port.

4. A switch according to claim 1, in which the scheduler comprises plural cell state buffers for receiving and storing data about data frames received at one or more of the input ports.

5. A switch according to claim 1, in which there is a dedicated cell state buffer for each of the plural input ports.

6. A switch according to claim 1, in which the cut-through arbiter is arranged to select from the data cells in respect of which there is data about in one or more of the cell state buffers a data cell for transmission and when decided to communicate with the respective input port and the switch fabric to cause the selected data cell to be switched.

7. A switch according to claim 1, in which the selection is made in dependence on one or more parameters of the data cells selected from a group consisting of:
(a) the time that the data cell has been stored at the input port;
(b) in the case of a multicast data cell, the fan-out of the data cell;
(c) the availability of the designated destination(s) of the data cell; and
(d) the required connection rate and duration of the flow of which the data cell is a part.

8. A switch according to claim 2, wherein after the cut-through arbiter has operated in a switching cycle, one or more of the cell arbiter stages operates to schedule connections, wherein the cell arbiter stage is arranged only to schedule single cells for transmission to each egress port independent of other characteristics of the cell.

9. A switch according to claim 1, comprising a crossbar interface for communicating to the switch fabric the required configuration for each switching cycle.

10. A switch according to claim 1, in which the cut through arbiter comprises a connection queue for use in scheduling the transmission of an entire cell, the connection queue being arranged in use to hold information about which frame at which ingress port is to have a cell scheduled at various times in the future.

11. A network of data switches interconnected by physical links, wherein at least one of the switches is a switch according to claim 1.

12. A method of switching data cells across a data switch, the switch comprising plural input ports and plural output ports, a switch fabric for selectively enabling a data cell received at one of the plural input ports to be switched to one or more of the plural output ports and a switch scheduler comprising a cut-through arbiter arranged to schedule the switching of a received data cell before the entirety of the data frame of which it is a part is received, the method comprising:
at one of the input ports, starting to receive a data frame for onward transmission;
as the data frame is received, dividing the data frame into data cells for handling by the switch;
and pre-scheduling the onward transmission of the entire set of data cells which comprise the data frame before the whole data frame has been received.

13. A method according to claim 12, wherein upon the start of receipt of a frame at an input port, data about the frame is communicated to the switch scheduler.

14. A method according to claim 13, wherein the data about the frame is stored in a cell state buffer for the port at which the frame is received.

15. A method according to claim 14, comprising selecting from the data cells in respect of which there is stored data about in one or more of the cell state buffers, a data cell for transmission; and,
when selected, communicating with the respective input port and the switch fabric to cause the selected data cell to be switched.

16. A switch according to claim 15, in which the selection is made in dependence on one or more parameters of the data cells selected from a group consisting of:
(a) the time that the data cell has been stored at the input port;
(b) in the case of a multicast data cell, the fan-out of the data cell;
(c) the availability of the designated destination(s) of the data cell; and
(d) the required connection rate and duration of the flow of which the data cell is a part.

17. A method according to claim 16, comprising, after the cut-through arbiter has operated, scheduling the transmission of single cells for transmission to each egress port independent of other characteristics of the cell.

18. A method according to claim 12, wherein the pre-scheduling of an entire data frame is achieved with a connection mask representative of plural switching cycles.

19. A method according to claim 18, wherein a bit is set in respect of each slot which is to be dedicated to a cell from the data frame.

20. A method according to claim 12, in which the rate of data movement through the switch is varied by the pre-scheduling of the data frame.
